(19) United States
(12) Patent Application Publication
(10) Pub. No.: US 2016/0307063 A1
(43) Pub. Date: Oct. 20, 2016

(54) DICOM DE-IDENTIFICATION SYSTEM AND METHOD

(71) Applicant: Synaptive Medical (Barbados) Inc., Bridgetown (BB)

(72) Inventors: Stewart Bright, Courtice (CA); Kelly Noel Dyer, Toronto (CA); Wesley Bryan Hodges, London (CA); Jonathan Edward Resnick, Toronto (CA)

(21) Appl. No.: 14/688,386

(22) Filed: Apr. 16, 2015

(51) Int. Cl. G06K 9/34; G06F 19/00; G06T 1/20; G06K 9/00; G06T 7/00; G06T 11/60

(52) U.S. Cl. CPC G06K 9/344; G06T 7/0081; G06T 11/60; G06T 1/20; G06K 9/00463; G06F 19/321; G06K 2209/01

(57) ABSTRACT

A system for creating de-identification programs for de-identifying DICOM image files containing DICOM images and metadata. The system provides a user interface that allows users to create de-identification programs. Each program has redaction rules specifying redaction regions in normalized coordinates defining a region of a DICOM image to be redacted to obfuscate content in the redaction region, and metadata substitution rules specifying metadata elements to be substituted with pseudonyms. The user may modify the redaction rules and metadata substitution rules, and preview the effect of the de-identification program by applying the de-identification program to DICOM images and associated metadata and displaying the resulting modified DICOM image and associated metadata. The system maintains a pseudonym memory to determine if a pseudonym has been stored for each metadata element specified by the substitution rule so that the same pseudonym is consistently used for the same element values.

### FIELD OF THE INVENTION

The present invention relates generally to computer systems that perform de-identification of medical imagery, and more particularly to computer file systems that that perform de-identification of DICOM images.

### BACKGROUND OF THE INVENTION

Due to the need to protect confidentiality of patient information, use of medical images in any context outside of the clinical context in which the images were acquired, such as for research, teaching, and within industry, requires that the images be de-identified (or “anonymized”) in order to remove personal information contained in the images files. In the case of DICOM images, there is generally sensitive information both in the images themselves and in the meta-data stored in DICOM headers. Such information in the meta-data must be deleted or replaced. Other sensitive information may include text overlays that are “burned in” to the image pixel data.

The basic problem of cleaning the meta-data in an image file is simple, and indeed the DICOM standard itself specifies how meta-data values should be transformed or removed in order to meet various de-identification needs. A variety of software tools, both commercial and free/open-source, exist to perform aspects of this basic task. However, these tools are generally not designed to serve the complex needs of real-world de-identification use cases; in particular, they are lacking in a number of areas, as discussed below.

A de-identification system ideally should be sufficiently customizable to support a wide variety of de-identification scenarios, but there is a trade-off between customizability and ease-of-use. Some systems opt for simplicity and allow configuration via a GUI, which often suffices for common scenarios but precludes advanced customization in those scenarios that require it. Other systems opt for flexibility, and define a domain-specific programming language to allow users to program the system to meet their needs. This approach supports advanced customization, but requires the user to invest time in learning the language and programming the system. This may prevent less technically-inclined users from effectively using the system in basic scenarios that do not require advanced customization.

Prior art systems are also deficient with respect to metadata selection. Even those de-identification systems that allow for a high degree of programmability lack the ability to unambiguously select nested DICOM attributes to be removed or modified.

Prior art systems are also deficient with respect to verifiability. The more programmable a de-identification processor is, the more difficult it is for the user to reason effectively about the results of applying the processor to a given image. Successful use of a programmable de-identification system often becomes an iterative trial and error process, during which the user alternately refines the program and verifies that it has the intended effect, involving the steps:
1. the user refines the program;
2. the user applies the program to a sample set of input images; and
3. the user inspects the output (de-identified) images to verify that the program has achieved the intended effect and the resulting images are acceptably de-identified, and if not, steps 1-3 are repeated until acceptable results are achieved.

This trial and error process may be very time-consuming.

Prior art systems are also deficient with respect to pseudonymization. Whereas de-identification of a single image or study may be a relatively straightforward undertaking, it is often the case that numerous studies related to a single patient must be de-identified consistently such that the overall integrity of the patient record is maintained. This includes, at minimum, consistent use of aliases (e.g. patient name, patient ID), but may also include maintaining temporal relationships (e.g. elapsed time between initial study and a follow-up study). Furthermore, it is not always the case that all of these studies are available for processing at a given point in time; the patient record can be said to extend into the future, and it may be a requirement that future studies acquired for a given patient are de-identified consistently with those that have already been processed. This implies that the de-identification system must have “memory”; that is, it must be able to keep track of the de-identification operations—including aliases and temporal shifts—that were applied to a study, so that these same operations can be applied to future studies. De-identification that preserves this consistency across studies is referred to as “pseudonymization” (as opposed to “anonymization”), because a pseudonymous identity is effectively constructed for the patient.

Regarding cleaning of identifying information in text overlays that are “burned in” the image pixel data, the basic problem of redacting identifying text that is “burned in” to image pixel data is a relatively trivial task for a human provided with some pixel editing software. The challenge lies in the problem of redacting identifying text across large numbers of images without requiring human attention to each image. However, this is complicated by the fact that the relevant text is not always located in the same place across all images. In practice though, the location of the text varies depending on the dimensions of the image and on the particularities of the scanner that produced the image.

One approach to this problem is to make use of optical character recognition (OCR) technologies to automatically locate identifying text information within an image. There are challenges associated with this approach and it is often does not work well in practice, and so it is not widely employed.

### SUMMARY OF THE INVENTION

In various examples, the present disclosure provides a de-identification system for creating de-identification programs for de-identifying DICOM image files containing DICOM images and metadata. The system includes an electronic interface for receiving DICOM image files, and a computer processor electronically connected to the electronic interface. The computer processor is configured to perform a number of functions. The processor provides a user interface to receive input from a user, and displays DICOM images and associated metadata to the user. Based on user input, the processor creates a de-identification program. A de-identification program has at least one user-specified redaction rule and at least one user-specified metadata substitution rule. Each redaction rule specifies a redaction region in normalized coordinates defining a region of the DICOM image to be redacted to obfuscate content in the redaction region. Each metadata substitution rule specifies a metadata element to be substituted with a pseudonym. The processor is configured to allow the user to modify the de-identification program by specifying how to modify a redaction rule contained in the de-identification program, or by specifying how to modify a metadata substitution rule contained in the de-identification program. The processor is further configured to preview the effect of the de-identification program by applying the de-identification program to a DICOM image and associated metadata and displaying the resulting modified DICOM image and associated metadata to the user. Applying the de-identification program involves modifying the DICOM image to obfuscate information in the redaction region specified by each redaction rule, and applying each metadata substitution rule. Applying a metadata substitution rule involves checking a pseudonym memory maintained by the processor for the de-identification program to determine if a suitable pseudonym value previously used to replace the metadata element specified by the substitution rule has been stored. If such a pseudonym value has been stored for the metadata element value, then the processor replaces the metadata element value with the stored pseudonym value, or otherwise the processor generates and stores in the pseudonym memory for the de-identification program a pseudonym value for the metadata element value and replaces the metadata element value with the generated pseudonym value.

The user may specify a redaction region by drawing, via the user interface, a rectangle over a displayed DICOM image or by modifying a previously specified rectangle displayed over a displayed DICOM image.

The metadata substitution rules may contain DICOM tag paths specifying one or more nested DICOM metadata elements, the value of each element to be substituted with a pseudonym value. Some of the DICOM tag paths may contain a wildcard expression.

The de-identification program may be a script stored by the computer processor in a memory, and the system may allow the user to directly edit stored de-identification programs.

Obfuscating information in the redaction region may be done by replacing the image data in the redaction region with other data.

Pseudonyms may be strings of pseudo-random characters.

The values of the metadata element specified by the substitution rule may be indexed in the pseudonym memory by DICOM patient ID, and a stored pseudonym value may then be considered to be suitable if it has previously been used to replace the value of the metadata element in a DICOM file associated with the same patient ID. In other embodiments, a stored pseudonym value may be considered to be suitable if it has previously been used to replace the value of the metadata element.

If a suitable pseudonym value has not been stored for a value of a metadata element specified by the substitution rule, then generating the pseudonym value may consist of requesting the user to enter a character string to be the pseudonym value.

The pseudonym value for a metadata element that is a date or time associated with the production of the DICOM image may be a different date or time that is offset from the value of the metadata element by an offset value, where the de-identification program generates pseudonym values for all metadata element values that are dates or times associated with the production of the DICOM image by adding the same offset value to the metadata element values.

The computer process may be further configured to receive a DICOM study containing DICOM image files via the electronic interface and to apply one of the de-identification programs created by the de-identification system to the DICOM image and metadata in each DICOM image file in the DICOM study to de-identify all the DICOM image files in the study.

For at least one of the de-identification programs, the suitable pseudonym value associated with each metadata element value may be selected to be unique for that metadata element value processed by the de-identification program. The computer processor may be further configured to store re-identification data specifying, for each pseudonym value, the value of the metadata element that the pseudonym value replaced. Then the computer processor may be further configured to receive a DICOM image file that has been de-identified by the system, and to re-identify the DICOM image file by replacing each pseudonym in the DICOM image file with the value of the metadata element that the pseudonym replaced, according to the re-identification data.

Embodiments of the invention also provide a de-identification system for de-identifying DICOM image files. Such systems include an electronic interface for receiving DICOM image files, and a computer processor electronically connected to the electronic interface. The computer processor is configured to receive a de-identification program created by the system as described above, receive multiple DICOM image files, and then for each of the DICOM image files, apply the de-identification program to the image file. This is done by modifying the DICOM image in the DICOM image file to obfuscate information in the redaction region specified by each redaction rule specified in the de-identification program, and, for each metadata substitution rule, checking a pseudonym memory maintained by the processor for the de-identification program to determine if a suitable pseudonym value previously used to replace the value of the metadata element specified by the substitution rule has been stored, and if such a pseudonym value has been stored for the metadata element value, then replacing the metadata element value in the DICOM image file with the stored pseudonym value, or otherwise generating and storing in the pseudonym memory for the de-identification program a pseudonym value for the metadata element value and replacing the metadata element value with the generated pseudonym value. The multiple DICOM image files may constitute a DICOM study.

The present disclosure also discloses a method of de-identifying DICOM image files containing DICOM images and metadata using a de-identification system that has an electronic interface for receiving DICOM image files and a computer processor electronically connected to the electronic interface. The method involves first receiving via the electronic interface a DICOM image file, and then displaying the DICOM image and associated metadata in the DICOM image file to the user. Based on user input, the processor creates a de-identification program. The de-identification program has at least one user-specified redaction rule and at least one user-specified metadata substitution rule. Each redaction rule specifies a redaction region in normalized coordinates defining a region of the DICOM image to be redacted to obfuscate content in the redaction region. Each metadata substitution rule specifies a metadata element to be substituted with a pseudonym. The processor then applies the de-identification program to the DICOM image file by modifying the DICOM image in the DICOM image file to obfuscate information in the redaction region(s) specified by each redaction rule, and, for each metadata substitution rule, checking a pseudonym memory maintained by the processor for the de-identification program to determine if a pseudonym value previously used to replace the value of the metadata element specified by the substitution rule has been stored, and if a such pseudonym has been stored for the metadata element, then replacing the metadata element value with the stored pseudonym value, or otherwise generating and storing in the pseudonym memory for the de-identification program a pseudonym value for the metadata element value and replacing the metadata element value with the generated pseudonym value. The processor then displays the modified DICOM file to the user. The user may instruct the processor to modify the de-identification program by specifying how to modify a redaction rule contained in the de-identification program, or by specifying how to modify a metadata substitution rule contained in the de-identification program. The process of modifying the de-identification program and displaying the results of applying the modified de-identification program to the DICOM image file may be repeated as instructed by the user.

Related inventions were described in PCT application no. PCT/CA2014/000482, which is hereby incorporated herein by reference in its entirety.

### BRIEF DESCRIPTION OF THE DRAWINGS

FIG. 1 depicts the effects of a de-identification program operating on two DICOM studies.

FIG. 2 shows an example user interface that may be presented by the de-identification system.

FIG. 3 depicts the effects of two de-identification programs operating on one DICOM study.

FIG. 4 depicts an image with some text burned in to the upper left portion of the image.

FIG. 5 depicts the image of FIG. 4 with a rectangle delimiting a redaction region of the image that contains text that needs to be removed.

FIG. 6 depicts the image of FIG. 4 after the text in the redaction region has been removed.

### DETAILED DESCRIPTION OF THE INVENTION

The Programmable Memorizing DICOM De-identification (PMDD) system is a de-identification module that may be a stand-alone application or may be included as a component of an integrated software application. It provides de-identification capabilities that go beyond those offered by existing solutions.

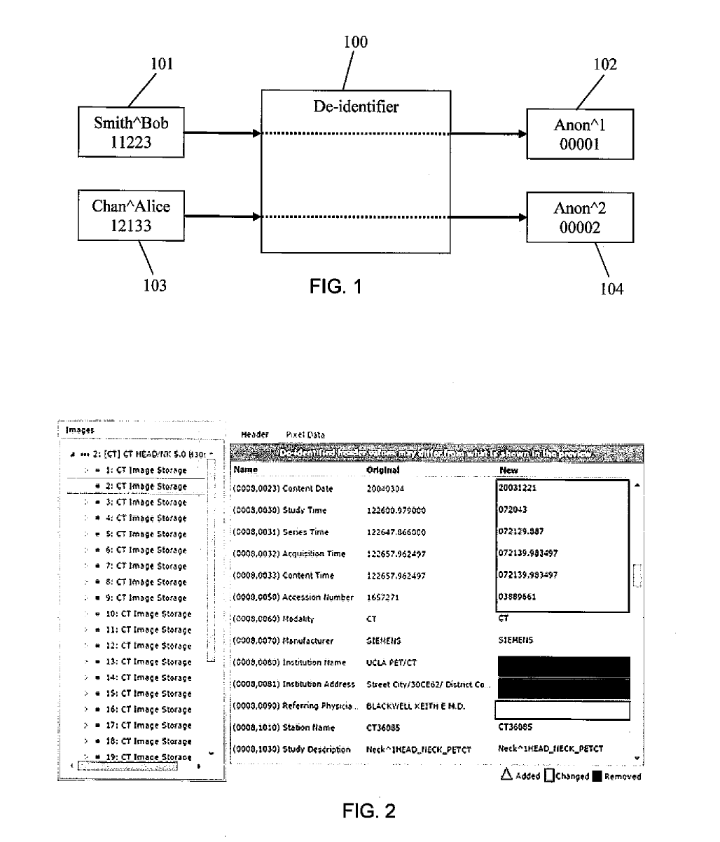

In the context of PMDD, a “de-identifier” 100 is a logical entity that can be conceptualized as a “machine” that accepts DICOM image files 101, 103 (which may constitute a DICOM study) as input and produces de-identified image files 102, 104 as output as depicted schematically in FIG. 1. In the example depicted in FIG. 1, one or more image files for the patient with the name Bob Smith (“SmitĥBob”) and patient ID 11223 are edited by the de-identifier 100 to change all instances of “SmitĥBob” in the image headers to “Anon̂2” and to change all instances of patient ID “11223” in the image headers to “00001”.

A user of the PMDD can define any number of de-identifiers within the system. Each de-identifier is independently programmable and has a dedicated pseudonym memory for that specific de-identifier.

PMDD balances the needs of customizability and ease-of-use by providing both GUI-driven and script-based programmability. When a user creates a de-identifier, the user typically begins by using the configuration graphical user interface (GUI) provided by the PMDD to perform basic programming of the de-identifier. The selections made via the configuration GUI are used as input by the de-identifier to generate a de-identification program, preferably in the form of a script. For many or most common scenarios, this generated program will suffice, and no further customization is required. However, for advanced scenarios requiring finer customization, the PMDD provides the user with the option to directly modify the generated script, which effectively allows for unlimited flexibility. Other systems do not employ the hybrid approach described here whereby a GUI is used to generate a base script that can then be further customized.

Unlike prior art systems, PMDD employs a “DICOM tag path” domain-specific language that supports precise selection of nested attributes. The tag path language supports wildcards, which can lead to more concise scripts in the case where the same operation needs to be applied to all attributes that match the wildcard expression. Examples of tag path expressions are shown in the table below.

| Path | Meaning |
|---|---|
| (0010, 0020) | Selects Patient ID, at the root level only. |
| //(0010, 0020) | Selects Patient ID, everywhere it occurs, even in |
| | sequences. |
| (0008, 1120) | Selects Referenced Patient Sequence, at the root |
| | level only. |
| (0008, 1120)/ | Selects all Patient IDs in all sequence items |
| (0010, 0020) | within the Referenced Patient Sequence at the |
| | root level. |
| (0008, 1120)[1]/ | Selects Patient ID in the first sequence item |
| (0010, 0020) | within the Referenced Patient Sequence at the |
| | root level. |
| (0008, 1120)[2]/ | Selects Patient ID in the second sequence item |
| (0010, 0020) | within the Referenced Patient Sequence at the |
| | root level. |
| (0008, 00xx) | Selects all group 8 attributes, where the element |
| | starts with 00. The x character functions as a |
| | wildcard. Some attributes that would be selected |
| | by this include things like Modality (0008, 0060), |
| | Institution Name (0008, 0080) and Institution |
| | Address (0008, 0081). |

Such flexible attribute specification can be useful for various reasons. For example, DICOM allows any number of alternate Patient IDs to be associated with one patient, via an attribute called OtherPatientIdsSequence, where each item in the sequence represents an alternate ID. In some scenarios it may be desirable to alias each of these IDs separately to a different pseudonym. It would be impossible to do so without being able to access each sequence item individually, as is facilitated by the use of the PMDD's tag path language. Without the tag paths, there would be no way to modify these alternate Patient IDs independently of the primary Patient ID.

An example of such a specification is shown in the following code:

realPatientIds = get (“OtherPatientIdsSequence/PatientId”);
foreach (realPatientId in realPatientIds)
{

mappedPatientId = customMapOtherPatientId (realPatientId.Value);
set (realPatientId.Path, mappedPatientId);

};
remove_except (“OtherPatientIdsSequence/(xxxx,xxxx)”,
“OtherPatientIdsSequence/PatientId”);

The path returned by “get”, which is reflected in realPatientId.Path, is exact (e.g. OtherPatientIdsSequence[1]/PatientId). The remove_except call above gets rid of everything else in the sequence, except for the Patient Id. At some point in the future, a complete study for one of these other patient IDs might be encountered, and the remainder of the mapping could be completed then (also via script customization), but the mapping integrity would not be compromised.

The availability of such tag path specification provides a way to have full access to and control over the data in the entire DICOM header while maintaining a simple, flat application programming interface (API) (e.g. remove(path), set(path, value)), and eliminating unnecessary recursive calls to modify specific elements when the goal is to do the same thing to all of them.

PMDD also provides users with tools to help them reason about the programs they create and verify that a program achieves its intended effects. PMDD provides a live preview GUI to help with this. An example screen, showing a portion of a DICOM header as it would be de-identified according to the program as presently configured is shown in FIG. 2. The preview allows the user to visualize the effect that a de-identification program will have on a sample input dataset, without leaving the program development context. Changes made to the program, either via the configuration GUI, or by directly editing the script, are immediately applied to a sample dataset of the user's choosing, and the results displayed in a neighbouring window, such as that shown in the right side of FIG. 2. This greatly shortens the feedback cycle for users to be able to empirically verify the correctness of the program.

PMDD supports pseudonymization by memorizing generated pseudonyms and retaining them in persistent storage known as the pseudonym memory. By “memorization”, it is meant that whenever a pseudonym is introduced for a given piece of input data, that pseudonym is remembered in context of the information in the input data it replaced, so that, in the event that same piece of input data passes through the de-identifier again in future, the same pseudonym will be recalled and used as a substitute for the same information in the input data. It is not necessarily the case that the mapping from data to pseudonyms is invertible. For example, two patients with different names may be assigned pseudonyms for the patient name that are the same. In some embodiments, the pseudonyms are unique for each metadata element processed by the de-identification program so that the mapping is invertible.

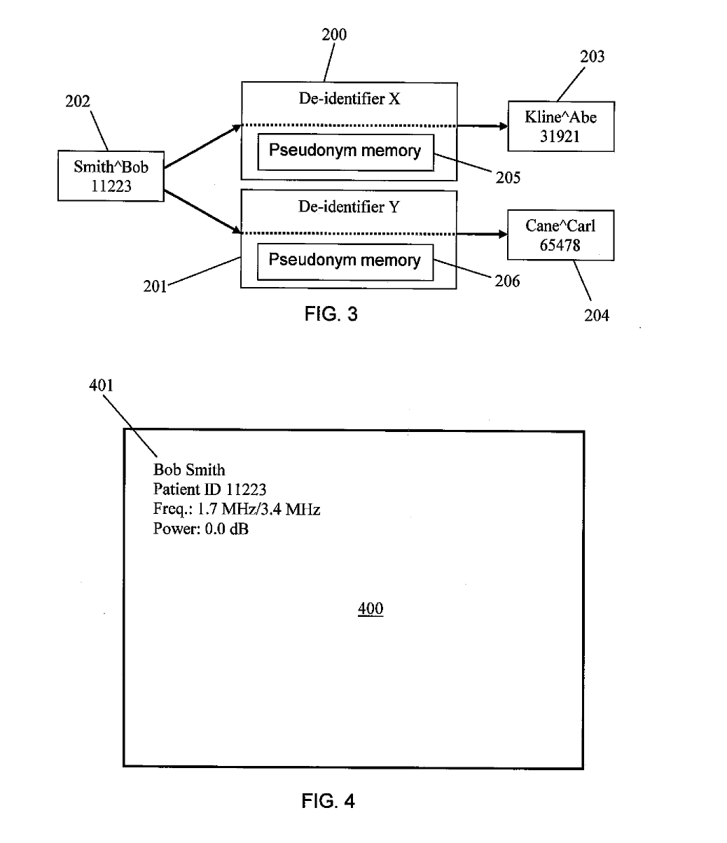

Processing of a DICOM study 202 by two different de-identifiers 200, 201 is depicted in a simple example in FIG. 3. In the simple scenario depicted in FIG. 3, the user creates a new de-identifier, called X 200, and programs X 200 to alias the Patient ID in each DICOM image file to a randomly generated replacement value (a pseudonym). PMDD provides multiple strategies for generating replacement values; random (or pseudo-random) generation is just one example. Generally a pseudonym may be any sequence of characters (including numbers and special characters, and in some cases blanks).

A study 202 is provided as input to X. The study 202 contains Patient ID “11223”. De-identifier X 200 consults its pseudonym memory, and finds that it has never seen the value “11223” as an input Patient ID before. In that case, it generates a random replacement value “31921” and assigns this value to the output study 203.

Sometime later, a second study 202 is provided as input to de-identifier X 200. This study also contains Patient ID “11223”, indicating that it belongs to the same source patient. De-identifier X 200 then consults its pseudonym memory 205, and finds that it has previously encountered Patient ID “11223”, and that it was aliased to “31921”. De-identifier X therefore assigns the Patient ID “31921” to the output study, replacing all instances of Patient ID “11223” with Patient ID “31921”.

Similarly, in some embodiments, the Patient Name, “Bob Smith”, when first seen by de-identifier X 200 causes de-identifier X 200 to generate the pseudonym “Abe Kline”, and replace all instances of Patient Name “Bob Smith” with “Abe Kline” in the output study 203. Then when the Patient Name “Bob Smith” is detected by de-identifier X 200 in a later study, all instances of Patient Name “Bob Smith” in that input study are also replaced with “Abe Kline” in the corresponding output study.

In preferred embodiments, the pseudonyms for elements such as patient name and birth date may be associated in the pseudonym memory 205 with the patient ID which can be used as a key. This may be advantageous since the patient ID is generally unique, whereas the patient name, for example, may not be. Then, in the example discussed above, when the de-identifier X 200 looks up the input Patient ID “11223” in the pseudonym memory 205, it finds that it should alias the Patient ID to “31921” and also that it should alias the name of that patient to “Abe Kline”. In such embodiments, the Patient ID acts as the key for both Patient ID and Patient Name mappings. Then if another patient with the name Bob Smith is encountered, but with a different patient ID, a different pseudonym for patient name is generated, stored and used to alias the second Bob Smith's name.

Had de-identifier X 200 not memorized the relationship between input Patient ID “11223” and output Patient ID “31921”, it would have generated a new random Patient ID for the second study, thus failing to preserve the relationship between the two studies in the pseudonymous domain.

The user may define other de-identifiers, such as de-identifier Y 201 shown in FIG. 3. De-identifier Y 201 maintains its own pseudonym memory 206 so that any image that passes through X belonging to (Bob Smith, 11223) in an input study 202 will be transformed to (Carl Cane, 65478) in the corresponding output study 204. As depicted in FIG. 3, different de-identifiers may map the same information (such as patient ID and name) to different pseudonyms. Consistency is enforced only within de-identification programs, which permits de-identification programs to be independent of each other.

With respect to the problem of redacting identifying text that is “burned in” to image pixel data, PMDD eschews the complexity of OCR-based approaches in favour of a simpler approach that requires a user to manually define, as part of the de-identifier programming step, a set of redaction rules. A redaction rule consists of a set of conditions that determine whether the rule is applicable to a given image, and a set of one or more rectangles representing the regions of the image to be redacted.

PMDD provides a GUI that allows a user to input rectangular regions by drawing upon displayed images in a sample input dataset of their choosing. For example, FIG. 4 shows an image 400 (actual image data not shown) with some text 401 burned in to the upper left portion of the image 400. The text 401 includes the patient name (Bob Smith) and the patient ID (11223). The actual image data is omitted from the depiction of the image 400 in FIGS. 4-6, although the PMDD would display the image to the user with the text 401 visible as part of the image. For example if the image is generally dark with black areas, the text may be superimposed as white text.

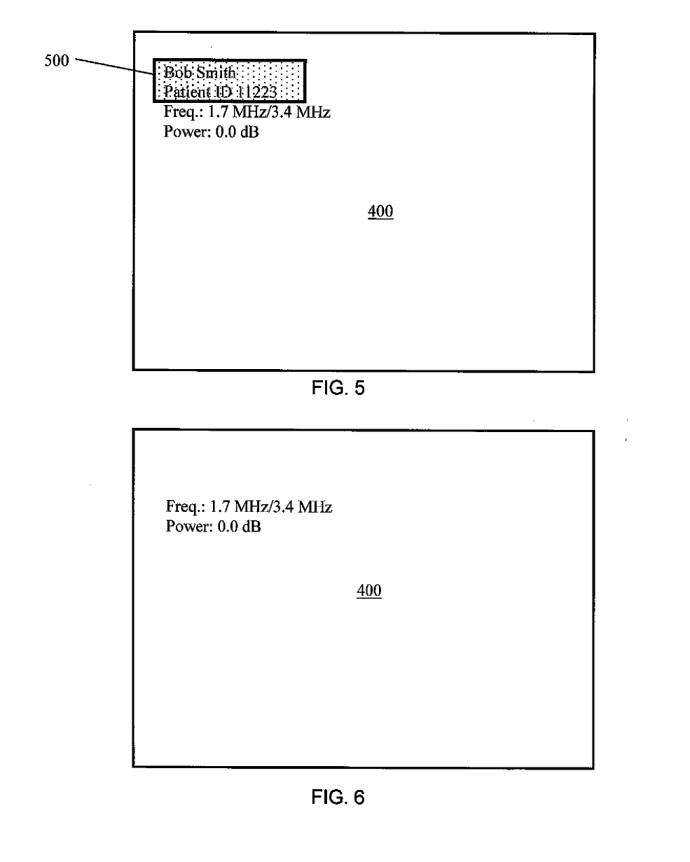

The PMDD GUI allows the user to draw a rectangle 500, as shown in FIG. 5, delimiting a portion (a “redaction region”) of the image that contains text that needs to be obfuscated or removed. Once the user has drawn the rectangle defining the redaction region, then the user can instruct the PMDD to perform the redaction(s) and display via a live preview GUI, a live preview screen such as is shown in FIG. 6, in order for the user to assess whether the change to the image removes all the sensitive data intended to be removed without removing an excessive amount of other information in the image. Once the user is happy with the results seen in the preview screen, the de-identifier containing the redaction rule based on the redaction region can be saved and used to de-identify study data, or the user may add one or more additional redaction rules specifying additional redaction regions to the de-identifier. The live preview GUI helps the user to quickly verify that a given set of rules is effective when applied to a variety of different images. The preview GUI allows the user to visualize the effect that the rules will have on a sample input dataset, without leaving the program development context.

The actual redaction can be done in various ways, as will be evident to skilled persons. For examples, for images from modalities where there are significant amounts of black background, the image data in the redaction region may simply be replaced by black pixels. Various other approaches may alternatively be employed, such as blurring the pixels in the redaction region, and in some embodiments the user may be given control over the method used to obfuscate the text.

It is a key aspect of the PMDD that rectangles (or other structures/means) defining redaction regions are represented internally in the system using normalized coordinates so that the representation is independent of the pixel dimensions of the sample input image upon which the rectangle is initially drawn. In this way, it is possible for the region to be applied to images whose pixel dimensions differ from the sample image. Assuming that the text positioning is consistent across the images in a relative sense (i.e. relative to the image dimensions), it is likely that one redaction rule will be successful on images of varying dimensions.

Of course, the shape of the redaction region need not be limited to rectangular. For example, in some embodiments, the user may be able to draw polygons with an arbitrary number of sides, and/or draw free-form borders for the redaction region. Also, the mechanism may of course be used to delete items other than or in addition to text. Although it is normally text that has been burned into the image that the user wishes to delete, it could also include other graphic data, such as a hospital logo.

Each rule can have one or more conditions that determine whether the associated redaction regions are applicable to a given image, based on its DICOM meta-data. For example, a rule might specify that the regions are applicable only if the Manufacturer of the scanner that produced the image is “Acme”, and the Model of the scanner is “X-1234”. In this way, regions can be applied selectively to a given image in order to match the expected location of the identifying text.

Redaction rules are part of the de-identification program associated with a de-identifier, and hence the rules can vary independently from one de-identifier to the next.

Generally, a computer, computer system, computing device, client or server, as will be well understood by a person skilled in the art, includes one or more than one computer processor, and may include separate memory, and one or more input and/or output (I/O) devices (or peripherals) that are in electronic communication with the one or more processor(s). The electronic communication may be facilitated by, for example, one or more busses, or other wired or wireless connections. In the case of multiple processors, the processors may be tightly coupled, e.g. by high-speed busses, or loosely coupled, e.g. by being connected by a wide-area network.

A computer processor, or just “processor”, is a hardware device for performing digital computations. A programmable processor is adapted to execute software, which is typically stored in a computer-readable memory. Processors are generally semiconductor based microprocessors, in the form of microchips or chip sets. Processors may alternatively be completely implemented in hardware, with hard-wired functionality, or in a hybrid device, such as field-programmable gate arrays or programmable logic arrays. Processors may be general-purpose or special-purpose off-the-shelf commercial products, or customized application-specific integrated circuits (ASICs). Unless otherwise stated, or required in the context, any reference to software running on a programmable processor shall be understood to include purpose-built hardware that implements all the stated software functions completely in hardware.

While some embodiments or aspects of the present disclosure may be implemented in fully functioning computers and computer systems, other embodiments or aspects may be capable of being distributed as a computing product in a variety of forms and may be capable of being applied regardless of the particular type of machine or computer readable media used to actually effect the distribution.

At least some aspects disclosed may be embodied, at least in part, in software. That is, some disclosed techniques and methods may be carried out in a computer system or other data processing system in response to its processor, such as a microprocessor, executing sequences of instructions contained in a memory, such as ROM, volatile RAM, non-volatile memory, cache or a remote storage device.

A non-transitory computer readable storage medium may be used to store software and data which when executed by a data processing system causes the system to perform various methods or techniques of the present disclosure. The executable software and data may be stored in various places including for example ROM, volatile RAM, non-volatile memory and/or cache. Portions of this software and/or data may be stored in any one of these storage devices.

Examples of computer-readable storage media may include, but are not limited to, recordable and non-recordable type media such as volatile and non-volatile memory devices, read only memory (ROM), random access memory (RAM), flash memory devices, floppy and other removable disks, magnetic disk storage media, optical storage media (e.g., compact discs (CDs), digital versatile disks (DVDs), etc.), among others. The instructions can be embodied in digital and analog communication links for electrical, optical, acoustical or other forms of propagated signals, such as carrier waves, infrared signals, digital signals, and the like. The storage medium may be the internet cloud, or a computer readable storage medium such as a disc.

Furthermore, at least some of the methods described herein may be capable of being distributed in a computer program product comprising a computer readable medium that bears computer usable instructions for execution by one or more processors, to perform aspects of the methods described. The medium may be provided in various forms such as, but not limited to, one or more diskettes, compact disks, tapes, chips, USB keys, external hard drives, wire-line transmissions, satellite transmissions, internet transmissions or downloads, magnetic and electronic storage media, digital and analog signals, and the like. The computer useable instructions may also be in various forms, including compiled and non-compiled code.

At least some of the elements of the systems described herein may be implemented by software, or a combination of software and hardware. Elements of the system that are implemented via software may be written in a high-level procedural language such as object oriented programming or a scripting language. Accordingly, the program code may be written in C, C++, J++, or any other suitable programming language and may comprise modules or classes, as is known to those skilled in object oriented programming. At least some of the elements of the system that are implemented via software may be written in assembly language, machine language or firmware as needed. In any case, the program code can be stored on storage media or on a computer readable medium that is readable by a general or special purpose programmable computing device having a processor, an operating system and the associated hardware and software that is necessary to implement the functionality of at least one of the embodiments described herein. The program code, when read by the computing device, configures the computing device to operate in a new, specific and predefined manner in order to perform at least one of the methods described herein.

While the teachings described herein are in conjunction with various embodiments for illustrative purposes, it is not intended that the teachings be limited to such embodiments. On the contrary, the teachings described and illustrated herein encompass various alternatives, modifications, and equivalents, without departing from the described embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Where, in this document, a list of one or more items is prefaced by the expression “such as” or “including”, is followed by the abbreviation “etc.”, or is prefaced or followed by the expression “for example”, or “e.g.”, this is done to expressly convey and emphasize that the list is not exhaustive, irrespective of the length of the list. The absence of such an expression, or another similar expression, is in no way intended to imply that a list is exhaustive. Unless otherwise expressly stated or clearly implied, such lists shall be read to include all comparable or equivalent variations of the listed item(s), and alternatives to the item(s), in the list that a skilled person would understand would be suitable for the purpose that the one or more items are listed.

The words “comprises” and “comprising”, when used in this specification and the claims, are to used to specify the presence of stated features, elements, integers, steps or components, and do not preclude, nor imply the necessity for, the presence or addition of one or more other features, elements, integers, steps, components or groups thereof.

What is claimed is:

1. A de-identification system for creating de-identification programs for de-identifying DICOM image files containing DICOM images and metadata, the system comprising:
(a) an electronic interface for receiving DICOM image files;
(b) a computer processor electronically connected to the electronic interface, the computer processor being configured to:
(i) provide a user interface to receive input from a user;
(ii) display a DICOM image and associated metadata to the user;
(iii) create a de-identification program based on user input, the de-identification program comprising at least one user-specified redaction rule, each redaction rule specifying a redaction region in normalized coordinates defining a region of the DICOM image to be redacted to obfuscate content in the redaction region, the de-identification program further comprising at least one user-specified metadata substitution rule, each metadata substitution rule specifying a metadata element to be substituted with a pseudonym;
(iv) modify the de-identification program based on user input specifying how to modify a redaction rule contained in the de-identification program;
(v) modify the de-identification program based on user input specifying how to modify a metadata substitution rule contained in the de-identification program;
(vi) preview the effect of the de-identification program by applying the de-identification program to a DICOM image and associated metadata and displaying the resulting modified DICOM image and associated metadata to the user, wherein applying the de-identification program comprises modifying the DICOM image to obfuscate information in the redaction region specified by each redaction rule, and, for each metadata substitution rule, checking a pseudonym memory maintained by the processor for the de-identification program to determine if a suitable pseudonym value previously used to replace the value of the metadata element specified by the substitution rule has been stored, and if such a pseudonym value has been stored, then replacing the metadata element value with the stored pseudonym value, or otherwise generating and storing in the pseudonym memory for the de-identification program a pseudonym value for the metadata element value and replacing the metadata element value with the generated pseudonym value.

2. The de-identification system of claim 1, wherein the user specifies a redaction region by drawing, via the user interface, a rectangle over the displayed DICOM image or by modifying a previously specified rectangle displayed over the displayed DICOM image.

3. The de-identification system of claim 1, wherein at least one of the metadata substitution rules contains a DICOM tag path specifying one or more nested DICOM metadata elements, the value of each element to be substituted with a pseudonym value.

4. The de-identification system of claim 3, wherein at least one of the DICOM tag paths contains a wildcard expression.

5. The de-identification system of claim 1, wherein the de-identification program is a script stored by the computer processor in a memory, and the system allows the user to directly edit stored de-identification programs.

6. The de-identification system of claim 1, wherein obfuscating information in the redaction region comprises replacing the image data in the redaction region with other data.

7. The de-identification system of claim 1, wherein the values of the metadata element specified by the substitution rule are indexed in the pseudonym memory by DICOM patient ID, and a stored pseudonym value is considered to be suitable if it has previously been used to replace the value of the metadata element in a DICOM file associated with the same patient ID.

8. The de-identification system of claim 1, wherein if a suitable pseudonym value has not been stored for the metadata element specified by the substitution rule, then generating the pseudonym value comprises requesting the user to enter a character string to be the pseudonym value.

9. The de-identification system of claim 1, wherein the pseudonym value for a metadata element value that is a date or time associated with the production of the DICOM image is a different date or time that is offset from the value of the metadata element by an offset value, and wherein the de-identification program generates pseudonym values for all metadata element values that are dates or times associated with the production of the DICOM image by adding the same offset value to the metadata element values.

10. The de-identification system of claim 1, wherein the computer processor is further configured to receive a DICOM study containing DICOM image files via the electronic interface and to apply one of the de-identification programs created by the de-identification system to the DICOM image and metadata in each DICOM image file in the DICOM study to de-identify all the DICOM image files.

11. The de-identification system of claim 1, wherein, for at least one of the de-identification programs, the suitable pseudonym value associated with a metadata element value is unique for each metadata element value processed by the de-identification program.

12. The de-identification system of claim 11, wherein the computer processor is further configured to store re-identification data specifying, for each pseudonym value, the value of the metadata element that the pseudonym value replaced.

13. The de-identification system of claim 12, wherein the computer processor is further configured to receive a DICOM image file that has been de-identified by the system, and to re-identify the DICOM image file by replacing each pseudonym value in the DICOM image file with the value of the metadata element that the pseudonym value replaced, according to the re-identification data.

14. A de-identification system for de-identifying DICOM image files, the system comprising:
(a) an electronic interface for receiving DICOM image files;
(b) a computer processor electronically connected to the electronic interface, the computer processor being configured to:
(i) receive a de-identification program created by the system of claim 1;
(ii) receive a plurality of DICOM image files; and
(iii) for each of the DICOM image files, modify the DICOM image in the DICOM image file to obfuscate information in the redaction region specified by each redaction rule specified in the de-identification program, and, for each metadata substitution rule, check a pseudonym memory maintained by the processor for the de-identification program to determine if a suitable pseudonym value previously used to replace the value of the metadata element specified by the substitution rule has been stored, and if such a pseudonym value has been stored, then replace the metadata element value in the DICOM image file with the stored pseudonym value, or otherwise generate and store in the pseudonym memory for the de-identification program a pseudonym value for the metadata element value and replace the metadata element value with the generated pseudonym value.

15. The de-identification system of claim 14, wherein the plurality of DICOM image files is a DICOM study.

16. A method of de-identifying DICOM image files containing DICOM images and metadata using a de-identification system comprising an electronic interface for receiving DICOM image files and a computer processor electronically connected to the electronic interface, the method comprising the steps of:
(a) receiving via the electronic interface a DICOM image file;
(b) displaying, by the processor, the DICOM image and associated metadata in the DICOM image file to the user;
(c) creating, by the processor, based on user input, a de-identification program, the de-identification program comprising at least one user-specified redaction rule, each redaction rule specifying a redaction region in normalized coordinates defining a region of the DICOM image to be redacted to obfuscate content in the redaction region, the de-identification program further comprising at least one user-specified metadata substitution rule, the metadata substitution rule specifying a metadata element to be substituted with a pseudonym;
(d) applying, by the processor, the de-identification program to the DICOM image file by modifying the DICOM image in the DICOM image file to obfuscate information in the redaction region specified by each redaction rule, and, for each metadata substitution rule, checking a pseudonym memory maintained by the processor for the de-identification program to determine if a suitable pseudonym value previously used to replace the value of the metadata element specified by the substitution rule has been stored, and if such a pseudonym value has been stored, then replacing the metadata element value with the stored pseudonym value, or otherwise generating and storing in the pseudonym memory for the de-identification program a pseudonym value for the metadata element value and replacing the metadata element value with the generated pseudonym value;
(e) displaying, by the processor, the modified DICOM file to the user;
(f) modifying, by the processor, the de-identification program based on user input specifying how to modify a redaction rule contained in the de-identification program or based on user input specifying how to modify a metadata substitution rule contained in the de-identification program; and
(g) repeating steps (d), (e) and (f) as instructed by the user.

17. The method of claim 16, wherein the user specifies a redaction region by drawing a rectangle over the displayed DICOM image or by modifying a previously specified rectangle displayed over the displayed DICOM image.

18. The method of claim 16, wherein at least one of the metadata substitution rules contains a DICOM tag path specifying one or more nested DICOM metadata elements, each element to be substituted with a pseudonym.

19. The method of claim 18, wherein at least one of the DICOM tag paths contains a wildcard expression.

20. The method of claim 16, wherein the de-identification program is a script stored by the processor in a memory, and the method further comprises a step of directly editing a stored de-identification program, by the processor, according to user instructions.
